(19) United States
(12) Patent Application Publication
(10) Pub. No.: US 2025/0244499 A1
(43) Pub. Date: Jul. 31, 2025

(54) METHOD OF ASSESSING PYRITE OXIDATION IN PETROLEUM SOURCE ROCK

(71) Applicant: SAUDI ARABIAN OIL COMPANY, Dhahran (SA)

(72) Inventor: Mohammad Abdulazim Alrowaie, Dhahran (SA)

(73) Assignee: SAUDI ARABIAN OIL COMPANY, Dhahran (SA)

(21) Appl. No.: 18/422,978

(22) Filed: Jan. 25, 2024

(51) Int. Cl. G01V 5/12; E21B 49/02

(52) U.S. Cl. CPC G01V 5/12; E21B 49/02

(57) ABSTRACT

A method of assessing a source rock is provided. The method may include selecting core samples of the source rock having high measured gamma-ray intensity. The method may further include measuring a sulfate-pyrite difference quantity in a first portion of the core samples and performing elemental analysis on a second portion of the core samples, where the elemental analysis comprises measuring uranium (“U”) concentration. The method may also include evaluating the gamma-ray intensity and the U concentration each for the presence of negative correlation with the sulfate-pyrite difference. Finally, the method may include associating a presence of both negative correlations with pyrite oxidation in the source rock.

### BACKGROUND

Formations used for hydrocarbon extraction from petroleum source rock can contain pyrite. Sedimentary shale is an example of such petroleum source rock, also termed herein source rock. Pyrite is a mineral with chemical formula FeS₂, iron disulfide. Sulfide, having the chemical formula S²⁻, is a species of sulfur. Other species of sulfur include sulfate, having chemical formula SO₄²⁻, and sulfite, having chemical formula SO₃²⁻. Pyrite oxidation in deep sediments to generate sulfate from sulfide in the pyrite can have an influence on reactions in the source rock environments that are sensitive to oxidation or reduction (“redox”). Thermochemical sulfate reduction reactions are an example of such redox-sensitive reactions. The outcomes of redox-sensitive reactions in turn can affect the properties of both the source rock and the hydrocarbons found in the source rock. Therefore, pyrite oxidation can affect the process of hydrocarbon extraction and the quality of the hydrocarbons.

Accordingly, there exists a need for methods of assessing pyrite oxidation in petroleum source rocks.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of assessing a source rock. The method may include selecting core samples of the source rock having high measured gamma-ray intensity. The method may further include measuring a sulfate-pyrite difference quantity in a first portion of the core samples and performing elemental analysis on a second portion of the core samples, where the elemental analysis comprises measuring uranium (“U”) concentration. The method may also include evaluating the gamma-ray intensity and the U concentration each for the presence of negative correlation with the sulfate-pyrite difference. Finally, the method may include associating a presence of both negative correlations with pyrite oxidation in the source rock.

In another aspect, embodiments disclosed herein relate to a method of assessing abiotic oxidation of pyrite by irradiation in petroleum source rocks. The method may include selecting core samples with high measured gamma-ray intensity, high total organic carbon (“TOC”), and high pyrite contents, where the core samples are of the petroleum source rocks, and where the petroleum source rocks are from a subsurface formation. The method may further include performing sulfur sequential extraction and sulfur isotope analysis to measure the difference between sulfur isotope composition of sulfate and pyrite, Δ³⁴S_{sulfate-pyrite}. The method may also include performing elemental analysis to measure contents of uranium (“U”) and other radioactive minerals and evaluating the gamma-ray intensity and the U contents for correlation with the measured Δ³⁴S_{sulfate-pyrite}. Finally, the method may include associating a negative correlation between U content and gamma-ray intensity on one side and the measured Δ³⁴S_{sulfate-pyrite} on another side with sulfate generated as a result of irradiation from uranium and the other radioactive minerals in the subsurface formation.

Other aspects and advantages of the claimed subject matter will be apparent from the following description and the appended claims.

### BRIEF DESCRIPTION OF DRAWINGS

FIG. 1 is a workflow for assessing oxidation of pyrite by uranium irradiation to generate sulfate in source rocks according to one or more embodiments of the present disclosure.

FIG. 2 is a workflow for assessing oxidation of pyrite by uranium irradiation to generate sulfate in organic rich source rocks according to one or more embodiments of the present disclosure.

FIG. 3 is a diagram showing a computer system according to one or more embodiments of the present disclosure.

FIG. 4 is a cross-plot of the measured gamma ray intensity from drill logs versus Δ³⁴S (‰), Δ³⁴S=δ³⁴S_{sulfate}−δ³⁴S_{pyrite} according to one or more embodiments of the present disclosure.

FIG. 5 is a cross-plot of uranium concentration (ppm) versus Δ³⁴S_{sulfate-pyrite} according to one or more embodiments of the present disclosure.

### DETAILED DESCRIPTION

In one aspect, embodiments disclosed herein relate to a method of assessing abiotic pyrite oxidation by uranium (“U”) irradiation in petroleum source rocks.

Sediments that are rich in organic matter are typically associated with high contents of uranium (U) and provide favorable conditions to form pyrite. However, few studies have been conducted to examine the effect of uranium irradiation on the sulfide minerals (e.g., pyrite) in marine black shale using deep cored samples.

The present disclosure provides a workflow to correlate sulfate origin to the uranium content in organic matter rich (“OM-rich”) source rock to better assess the sulfur species and sulfur cycle in Earth's deep past. The workflow examines the effect of uranium content on the sulfur speciation and the isotope composition of the source rock. The workflow includes the measurement of elemental abundance, gamma ray intensity, and sulfur isotopic compositions (“δ³⁴S”) of sequentially extracted sulfate and pyrite from cored samples from a subsurface. The source rock may be shale.

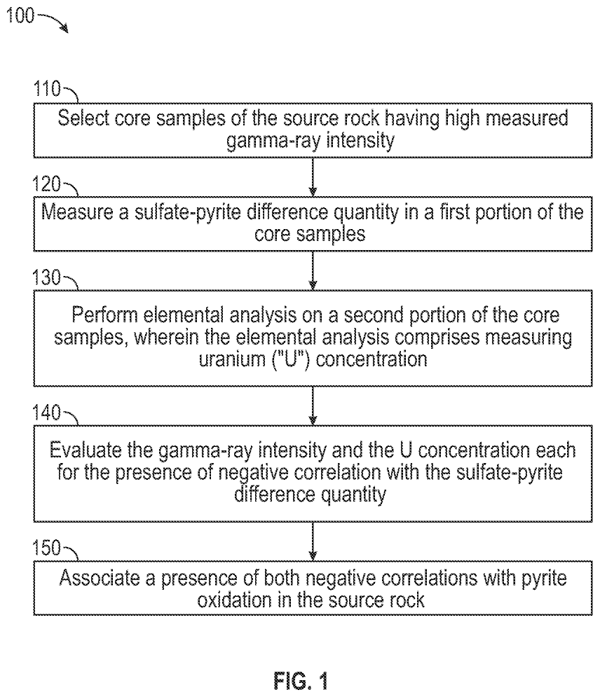

FIG. 1 illustrates a method according to one or more embodiments of the present disclosure. Method 100 includes: at block 110, selecting core samples of the source rock having high measured gamma-ray intensity; at block 120, measuring a sulfate-pyrite difference quantity in a first portion of the core samples; at block 130, performing elemental analysis on a second portion of the core samples, where the elemental analysis includes measuring uranium (“U”) concentration; at block 140, evaluating the gamma-ray intensity and the U concentration each for the presence of negative correlation with the sulfate-pyrite difference quantity; and at block 150, associating a presence of both negative correlations with pyrite oxidation due to uranium irradiation in the source rock.

In one or more embodiments, method 100 is directed to assessing a source rock. The source rock may include or be petroleum source rock. The source rock may include or be shale. The shale may include or be black shale. The source rock may be rich in organic matter and sulfide minerals (e.g., pyrite). The source rock may be rich in uranium. The source rock may be rich in potassium. The petroleum source rock may be from a subsurface formation. The subsurface formation may include or be a shale formation. The shale formation may include or be a black shale formation. The subsurface formation may include or be a petroleum reservoir. In one or more embodiments, the source rock is transferred to a laboratory.

At block 110, core samples are provided. The method may use cores by taking an amount from representative core samples from different depths. For example, the amount may be from 10 grams to 100 grams (“g”). In one or more embodiments, block 110 includes selecting core samples of the source rock having high measured gamma-ray intensity, ranging from 200 to more than 2,000 API. Gamma-ray intensity may be measured by wireline log methods known to one of skill in the art, performed at various depths along the sample. Method 100 may further include selecting the core samples for high pyrite contents. The core sample may include 2 wt % or more pyrite. Pyrite contents may be measured by inorganic content measurement methods known to one of skill in the art such as one or more of X-ray diffraction analysis and sequential extraction methods. Exemplary sequential extraction method are described herein. Method 100 may further include selecting the cores samples for high total organic carbon (“TOC”). The core sample may comprise 2 wt % or more organic carbon. TOC may be measured by organic content measurement methods known to one of skill in the art, for example pyrolysis. Samples selected for the investigation are freshly retrieved deep core, organic rich (high TOC) and contains log measurements (e.g., gamma ray intensity). Providing the selected core samples can include first collecting core samples and placing them in sealed canisters filled with an inert atmosphere to avoid and atmospheric oxidation of pyrite in the presence of oxygen, for storage. The inert atmosphere may include or be gaseous N₂. At the time of the analysis of stored samples, a quantity of each examined depth interval is to be collected for multiple analyses. The method may use cores by taking an amount from representative core samples from different depths. For example, the amount may be from 10 grams to 100 grams (“g”). Samples are desirably carefully handled, cleaned with a sonication bath using an aqueous solution to remove friable materials from exposed surface. The aqueous solution may be purified and/or deionized water. The purified and/or deionized water may be Milli-Q water (deionized, 18 MΩ). Then samples are freeze dried. Cleaned samples are then analyzed. The samples are desirable analyzed without delay to avoid any introduction of sulfate contamination from long-term exposure to oxygen.

At block 120, sulfur-containing species are measured. In one or more embodiments, block 120 includes measuring a sulfate-pyrite difference quantity in a first portion of the core samples. The sulfate-pyrite difference quantity may be the difference between sulfur isotope composition of sulfate and pyrite (“Δ³⁴S_{sulfate-pyrite}”). Measuring Δ³⁴S_{sulfate-pyrite} may include performing sulfur sequential extraction and sulfur isotope analysis. An exemplary method of sulfur sequential extraction and sulfur isotope analysis is described below in the general methods section of the examples.

At block 130, at least one radioactive mineral concentration is measured. In one or more embodiments, block 130 includes performing elemental analysis on a second portion of the core samples, where the elemental analysis includes measuring uranium (“U”) concentration. The elemental analysis may include measuring other radioactive minerals. The other radioactive minerals may include one or more of thorium (“Th”), vanadium (“V”) and potassium (“K”). An exemplary method of conducting the measurements is described below in the general methods section of the examples.

At block 140, the presence (or absence) of correlation is evaluated. In one or more embodiment, block 140 includes evaluating the gamma-ray intensity and the U concentration each for the presence of negative correlation with the sulfate-pyrite difference quantity. The evaluating may include identifying each core sample by gamma-ray intensity. The evaluating may include sorting the first and second portions according to gamma-ray intensity. Evaluating the U concentration for the presence of negative correlation with the sulfate-pyrite difference quantity may include: associating U concentration values for core samples in the second portion with sulfate-pyrite difference quantity values for core samples in the first portion having similar gamma-ray intensity to obtain a relationship between the U concentration and the sulfate-pyrite difference; and performing a regression on the relationship to determine the presence of negative correlation with the sulfate-pyrite difference. Evaluating the gamma-ray intensity for the presence of negative correlation with the sulfate-pyrite difference quantity may include associating gamma-ray values for core samples in the first portion with the sulfate-pyrite difference quantity values for the respective core samples to obtain a relationship between the U concentration and the sulfate-pyrite difference; and performing a regression on the relationship to determine the presence of negative correlation with the sulfate-pyrite difference. Determining the presence of oxidation of pyrite by uranium irradiation may include producing a cross plot between uranium concentration and the sulfur isotopic fractionation between sulfate and pyrite (Δ³⁴S_{sulfate-pyrite}). To determine the origin of sulfate in the source rock, sulfur isotopic composition of extracted sulfate is measured and compared to the sulfur isotopic composition of pyrite, radioactive mineral concentration, and gamma-ray intensity. Sulfate originates from the original seawater sulfate is characterized by enriched 34S values for the isotopic composition. In contrast, sulfate originates from the oxidation of pyrite is characterized by depleted 34S for the isotopic composition. The difference between the isotopic composition of extracted sulfate and pyrite can be used to identify the oxygenation of pyrite in a subsurface containing the source rock, such as a subsurface formation. The oxygenation of pyrite can be associated with high concentration of U and radioactive minerals in the presence of water. Oxidation of pyrite by radiolysis produces sulfate with little or no sulfur fractionation between the original pyrite and product sulfate. The isotopic fractionation between the extracted sulfate and pyrite from the source rock can be correlated with gamma ray intensity and contents of radioactive minerals measured at block 130.

At block 150, pyrite oxidation pyrite oxidation due to uranium irradiation is assessed. In one or more embodiments, block 150 includes associating a presence of both negative correlations with pyrite oxidation in the source rock. The pyrite oxidation may include or be abiotic oxidation. The pyrite oxidation may be due to irradiation. Sulfate may have been generated due to the irradiation. The irradiation may include or be uranium irradiation. The irradiation may further include irradiation from the other radiative minerals optionally measured at block 130. If it is observed that samples with high gamma ray intensity and radioactive minerals have negative correlation with the sulfur fractionation between the original pyrite and product sulfate, then this suggests that sulfate originated by the oxidation of pyrite by the radiolysis in the subsurface. If the difference between the values obtained using Δ³⁴S_{sulfate-pyrite} is less than 10‰, then one can conclude some of the sulfate in the sample was formed as a result of uranium irradiation. The negative correlation can be attributed to the abiotic oxidation of pyrite by uranium irradiation.

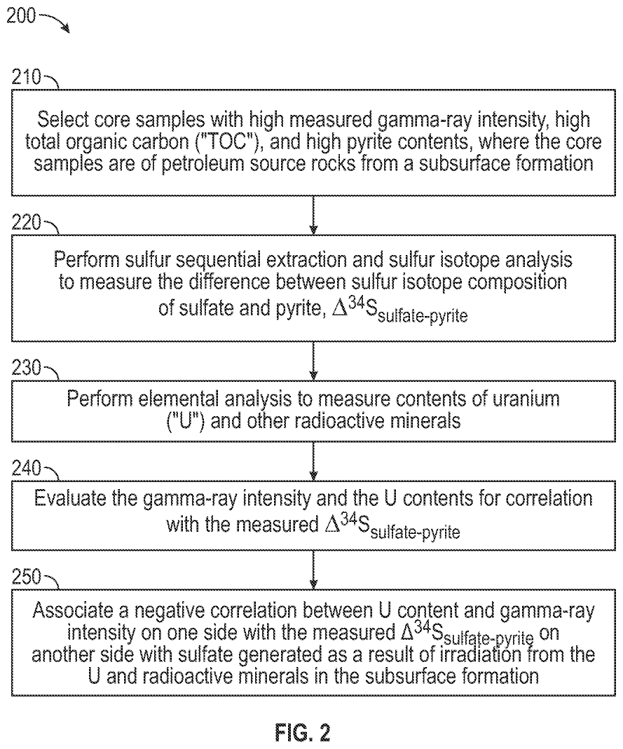

FIG. 2 illustrates a workflow according to one or more embodiments of the present disclosure. Workflow 200 is directed to assessing abiotic oxidation of pyrite by irradiation in petroleum source rocks. Workflow 200 is an illustrative embodiment of method 100. Workflow 200 includes: at block 210, selecting core samples with high measured gamma-ray intensity, high total organic carbon (“TOC”), and high pyrite contents, where the core samples are of the petroleum source rocks, wherein the petroleum source rocks are from a subsurface formation; at block 220, performing sulfur sequential extraction and sulfur isotope analysis to measure the difference between sulfur isotope composition of sulfate and pyrite, Δ³⁴S_{sulfate-pyrite}; at block 230, performing elemental analysis to measure contents of uranium (“U”) and other radioactive minerals; at block 240, evaluating the gamma-ray intensity and the U contents for correlation with the measured Δ³⁴S_{sulfate-pyrite}; and at block 250, associating a negative correlation between U content and gamma-ray intensity on one side and the measured Δ³⁴S_{sulfate-pyrite} on another side with sulfate generated as a result of irradiation from uranium and the other radioactive minerals in the subsurface formation.

At block 210, core samples from a subsurface formation that have been selected for high gamma-ray, total organic carbon (“TOC”), and pyrite contents are provided. Samples selected for the investigation are freshly retrieved deep core, organic rich (high TOC) and contains log measurements (e.g., gamma ray intensity . . . , etc). Samples can be collected from black shale. Providing the selected core samples can include first collecting core samples and placing them in sealed canisters filled with N₂ to avoid and atmospheric oxidation of pyrite in the presence of oxygen, for storage. At the time of the analysis of stored samples, 100 g of each interval is to be collected for multiple analyses. Sample should be carefully handled, cleaned with a sonication bath using Milli-Q water (deionized, 18 MΩ) to remove friable materials from exposed surface. Then samples are freeze dried. Cleaned samples are then analyzed without delay to avoid any introduction of sulfate contamination from long-term exposure to oxygen.

At block 220, sulfur sequential extraction and sulfur isotope analysis are performed on selected core samples, providing the values of the difference between sulfur isotope composition and pyrite (“Δ³⁴S_{sulfate-pyrite}”). An exemplary method of conducting the measurements is described below in the general methods section of the examples.

At block 230, elemental analysis is performed on selected core samples to measure metal and radioactive mineral concentrations, providing the concentrations of the elements uranium (“U”), thorium (“Th”), and potassium (“K”). An exemplary method of conducting the measurements is described below in the general methods section of the examples.

At block 240, the gamma ray and uranium concentration are evaluated for correlation with the difference between sulfur isotope composition and pyrite (“Δ³⁴S_{sulfate-pyrite}”). To determine the origin of sulfate in the black shale, sulfur isotopic composition of extracted sulfate is measured and compared to the sulfur isotopic composition of pyrite, radioactive mineral concentration, and gamma-ray intensity. Sulfate originates from the original seawater sulfate is characterized by enriched 34S values for the isotopic composition. In contrast, sulfate originates from the oxidation of pyrite is characterized by depleted 34S for the isotopic composition. The difference between the isotopic composition of extracted sulfate and pyrite can be used to identify the abiotic oxygenation of pyrite in subsurface and deep black shale (e.g., petroleum source rocks). The oxygenation of pyrite can be associated with high concentration of U and radioactive minerals in the presence of water. Oxidation of pyrite by radiolysis produces sulfate with little or no sulfur fractionation between the original pyrite and product sulfate. The isotopic fractionation between the extracted sulfate and pyrite from black shale can be correlated with gamma ray intensity and U, V, K, and Th contents.

At block 250, if there is a negative correlation at block 130, then a result is assessed that sulfate was generated as a result of the irradiation from radioactive minerals in the subsurface formation. If it is observed that samples with high gamma ray intensity and radioactive minerals have negative correlation with the sulfur fractionation between the original pyrite and product sulfate, then this suggests that sulfate originated by the oxidation of pyrite by the radiolysis in the subsurface. The negative correlation can be attributed to the abiotic oxidation of pyrite by uranium irradiation.

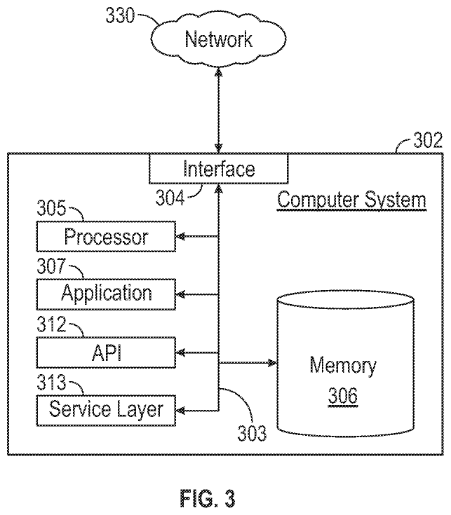

FIG. 3 shows a system in accordance with one or more embodiments. The computer system (302) is used to provide computational functionalities associated with described algorithms, methods, functions, processes, flows, and procedures as described in the present disclosure, according to one or more embodiments. The illustrated computer (302) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (302) may include a computer that includes an input device, such as a keypad, keyboard, touch screen, or other device that can accept user information, and an output device that conveys information associated with the operation of the computer (302), including digital data, visual, or audio information (or a combination of information), or a graphical user interface (GUI).

The computer (302) can serve in a role as a client, network component, a server, a database or other persistency, or any other component (or a combination of roles) of a computer system for performing the subject matter described in the instant disclosure. The illustrated computer (302) is communicably coupled with a network (330). For example, a generic computer (302), seismic processing system (306), and seismic interpretation workstation (308) may be communicably coupled using a network (330). In some implementations, one or more components of the computer (302) may be configured to operate within environments, including cloud-computing-based, local, global, or other environment (or a combination of environments).

At a high level, the computer (302) is an electronic computing device operable to receive, transmit, process, store, or manage data and information associated with the described subject matter. According to some implementations, the computer (302) may also include or be communicably coupled with an application server, e-mail server, web server, caching server, streaming data server, business intelligence (BI) server, or other server (or a combination of servers).

The computer (302) can receive requests over network (330) from a client application, for example, executing on another computer (302) and responding to the received requests by processing the said requests in an appropriate software application. For example, since seismic processing and seismic interpretation may not be sequential, each computer (302) system may receive requests over a network (330) from any other computer (302) and respond to the received requests appropriately. In addition, requests may also be sent to the computer (302) from internal users (for example, from a command console or by other appropriate access method), external or third-parties, other automated applications, as well as any other appropriate entities, individuals, systems, or computers.

The computer (302) includes an interface (304). Although illustrated as a single interface (1304) in FIG. 13, two or more interfaces (304) may be used according to particular needs, desires, or particular implementations of the computer (302). The interface (304) is used by the computer (302) for communicating with other systems in a distributed environment that are connected to the network (330). Generally, the interface (304) includes logic encoded in software or hardware (or a combination of software and hardware) and operable to communicate with the network (330). More specifically, the interface (304) may include software supporting one or more communication protocols associated with communications such that the network (330) or interface's hardware is operable to communicate physical signals within and outside of the illustrated computer (302).

The computer (302) also includes at least one computer processor (305). Although illustrated as a single computer processor (305) in FIG. 13, two or more processors may be used according to particular needs, desires, or particular implementations of the computer (302). Generally, the computer processor (305) executes instructions and manipulates data to perform the operations of the computer (302) and any algorithms, methods, functions, processes, flows, and procedures as described in the instant disclosure.

The computer (302) further includes a memory (306) that holds data for the computer (1302) or other components (or a combination of both) that can be connected to the network (330). For example, memory (306) can be a database storing data consistent with this disclosure. Although illustrated as a single memory (306) in FIG. 13, two or more memories may be used according to particular needs, desires, or particular implementations of the computer (302) and the described functionality. While memory (306) is illustrated as an integral component of the computer (302), in alternative implementations, memory (306) can be external to the computer (302).

The application (307) is an algorithmic software engine providing functionality according to particular needs, desires, or particular implementations of the computer (302), particularly with respect to functionality described in this disclosure. For example, application (307) can serve as one or more components, modules, applications, etc. Further, although illustrated as a single application (307), the application (307) may be implemented as multiple applications (307) on the computer (302). In addition, although illustrated as integral to the computer (302), in alternative implementations, the application (307) can be external to the computer (302).

Each of the components of the computer (302) can communicate using a system bus (303). In some implementations, any or all of the components of the computer (302), both hardware or software (or a combination of hardware and software), may interface with each other or the interface (304) (or a combination of both) over the system bus (303) using an application programming interface (API) (312) or a service layer (313) or a combination of the API (312) and service layer (313). The API (312) may include specifications for routines, data structures, and object classes. The API (312) may be either computer-language independent or dependent and refer to a complete interface, a single function, or even a set of APIs.

The service layer (313) provides software services to the computer (302) or other components (whether illustrated or not) that are communicably coupled to the computer (302). The functionality of the computer (302) may be accessible for all service consumers using this service layer. Software services, such as those provided by the service layer (313), provide reusable, defined business functionalities through a defined interface. For example, the interface may be software written in JAVA, C++, or other suitable language providing data in extensible markup language (XML) format or another suitable format. While illustrated as an integrated component of the computer (302), alternative implementations may illustrate the API (312) or the service layer (313) as stand-alone components in relation to other components of the computer (302) or other components (whether or not illustrated) that are communicably coupled to the computer (302). Moreover, any or all parts of the API (312) or the service layer (313) may be implemented as child or sub-modules of another software module, enterprise application, or hardware module without departing from the scope of this disclosure.

### EXAMPLES

General Method for Measuring Δ³⁴S_{sulfate-pyrite}

### Core Sample Preparation

To prepare a core sample, about 10 g of source rock material is thoroughly cleaned using a sonication bath with Milli-Q water (deionized, 18 MΩ) for four hours. After decanting the aqueous liquid, the sonication process is repeated three times to remove soluble or friable material from exposed surfaces. After air drying under room temperature, the dried and cleaned source rock material is powdered using an agate mortar and pestle.

### Sulfur Sequential Extraction

The powdered core samples may be sequentially extracted for sulfur species using the following method. First, the powdered core samples undergo solvent extraction for 24 h at 40° C. in a Soxhlet apparatus with 250 to 300 mL of dichloromethane (DCM) and about 1 to 3 g of activated copper granules. The copper granules are activated by serial rinses, at least twice in each, of 12 N HCl, Milli-Q water (deionized, 18 MΩ), acetone, DCM, and hexane before starting the solvent extraction. Subsequently, the DCM-soluble bitumen formed from the Soxhlet extraction is separated from the reacted copper granules and concentrated using a Brinkmann RE111 rotary evaporator. The separated reacted copper granules are then placed in a N₂-purged flask and reacted with 100 mL of heated 6 N HCl solution between 7° and 80° C. for 4 h to decompose elemental sulfur and form CuS. In the same flask, the CUS is then decomposed to evolve H₂S, which is carried by N₂ flow through a buffer solution of 0.1 M citrate solution at pH 4, into a 0.1 M AgNO₃ solution, where precipitation of Ag₂S occurs. The precipitated Ag₂S is then separated by filtration using baked, microfiber-quartz filters with retention of 0.22 μm. The filters with retained Ag₂S are dried in an oven at about 60° C. for 12 hours and then stored in a desiccator for isotopic analysis.

The residual powdered core sample from the DCM solvent extraction is placed in a N₂-purged flask and reacted with 6 N HCl solution at a temperature of about 60° C. for 4 h to volatize sulfur from decomposed acid-volatile sulfides (S_{AVS}) and monosulfides by trapping evolved H₂S as described above for CuS that had resulted from the reaction of elemental S with Cu. The acidic solution made in this step is then separated from the insoluble residue by centrifugation and decanting. The acidic solution is then used for acid soluble sulfate (S_{sulfate}) extraction and the rinsed solid residue is used for chromium reduction of disulfides, described below. The extraction of S_{sulfate} is achieved by reducing the pH of the acidic solution to 4 and adding excess 0.2 M Ba(NO₃)₂ solution to precipitate dissolved sulfate as BaSO₄. The BaSO₄ suspension is then centrifuged, decanted, and the residue dried for 24 h at 60° C. to be analyzed for isotopes.

The metallic disulfides, mainly pyrite, are extracted from the rinsed solid residue as chromium-reducible sulfur (S_{pyrite}) by reacting the rinsed solid residue with a mixture of 60 mL of 12 N HCl and 30 mL of 1.0 M chromium chloride (CrCl₂) in a N₂-purged extraction flask for 5 to 6 h. H₂S evolved from decomposition of disulfides is trapped as Ag₂S. S_{pyrite} extraction is repeated sequentially up to 5 to 6 times. The combined Ag₂S from S_{pyrite} extractions is filtered using baked, microfiber-quartz filters with retention of 0.22 μm and dried for 24 hours at less than 50° C. prior to isotope analysis.

### Sulfur Isotopic Analysis

Processed samples are purified and stored as silver sulfide, Ag₂S, and barium sulfate, BaSO₄, for isotope analysis. Samples of Ag₂S are powdered and homogenized using an agate mortar and pestle. About 0.4 mg of both sulfide and sulfate samples are loaded into tin capsules with 0.5 to 1 mg vanadium pentoxide (V₂O₅) powder. The sulfur stable isotope ratio ³⁴S/³²S is determined by first converting Ag₂S and BaSO₄ into SO₂ analyte gas via online combustion with an elemental analyzer at 980° C. Volatile products of the combustion are isotopically measured on an Isotope Ratio Mass Spectrometer to obtain Δ³⁴S values. Δ³⁴S_{sulfate-pyrite} is defined as the differences between the isotopic compositions of sulfur measured from the acid-soluble sulfate, Δ³⁴S_{sulfate}, and the sulfur from chrome reducible sulfide, Δ³⁴S_{pyrite}.

### Radioactive Mineral Concentration

An aliquot of 40 mg to 50 mg of powdered core sample is baked (ashed) for 12 hours at 550° C. to oxidize any organic material. The ashed sample is then transferred to a teflon digestion vessel and treated with several cycles of reverse aqua regia solution (3:1 vol:vol of concentrated HNO₃ and HCl) and 6 vol. % HF acid for 24 h at 180° C. The sample is then dried to remove HF and treated with 1:1 of HNO₃:HCl solution for 24 h at 180° C. until the sample is visually observed to be completely digested. The sample is then diluted in 0.32 M nitric acid prior to elemental analysis. Abundances of metals are measured using quadruple ICP-MS with a helium collision cell.

### Example 1

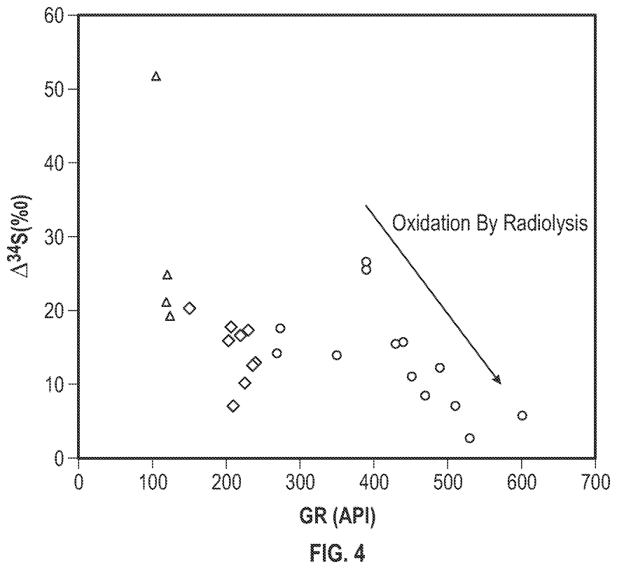

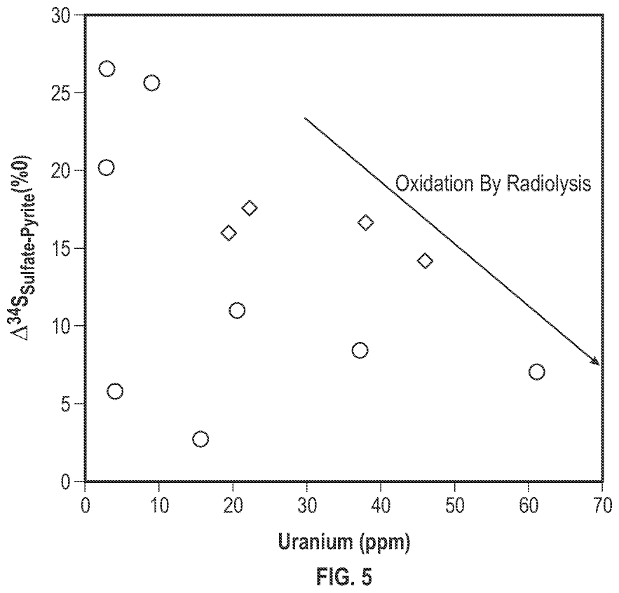

This example illustrates implementation of workflow 200 when the source rock is black shale. Isotopic fractionation was correlated between the extracted sulfate and pyrite from the black shale with gamma ray intensity and radioactive minerals (U, V, K, and Th) contents using the general procedures described above (FIG. 4 and FIG. 5). It was observed that core samples of the source rock with high gamma ray intensity and radioactive minerals had negative correlation with the sulfur fractionation between the original pyrite and product sulfate. This suggests that sulfate originated by the oxidation of pyrite by the radiolysis of source rock the in the subsurface. The negative correlation was attributed to the abiotic oxidation of pyrite by uranium irradiation.

Embodiments of the present disclosure may provide at least one of the following advantages. The present workflow enables a careful examination of the correlation between the gamma ray intensity, uranium contents, and sulfate origin. A negative correlation between the U concentration, low Δ³⁴S_{sulfate-pyrite} values, and high gamma ray intensity is consistent with abiotic oxidation of pyrite by radiolysis associated with radioactive minerals (e.g., U and Th) in the presence of water. A resulting understanding of the cause-effect of U-irradiation on the pyrite is of utmost significance for assessing the sulfur speciation and chemistry in the petroleum source rocks and reservoirs.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of assessing a source rock, comprising:
selecting core samples of the source rock having high measured gamma-ray intensity;
measuring a sulfate-pyrite difference quantity in a first portion of the core samples;
performing elemental analysis on a second portion of the core samples, wherein the elemental analysis comprises measuring uranium (“U”) concentration; and
evaluating the gamma-ray intensity and the U concentration each for the presence of negative correlation with the sulfate-pyrite difference;
associating a presence of both negative correlations with pyrite oxidation in the source rock.

2. The method of claim 1, wherein the source rock comprises petroleum source rock.

3. The method of claim 1, wherein the source rock comprises shale.

4. The method of claim 1, wherein the source rock is from a subsurface formation.

5. The method of claim 4, wherein the subsurface formation comprises a shale formation.

6. The method of claim 4, wherein the subsurface formation comprises a petroleum reservoir.

7. The method of claim 1, wherein selecting the core samples further comprises selecting the core samples for high pyrite contents.

8. The method of claim 1, wherein selecting the core samples further comprises selecting the core samples for high total organic carbon (“TOC”).

9. The method of claim 1, wherein the sulfate-pyrite difference quantity comprises the difference between sulfur isotope composition of sulfate and pyrite (“Δ³⁴S_{sulfate-pyrite}”).

10. The method of claim 9, wherein measuring the difference between sulfur isotope composition of sulfate and pyrite comprises performing sulfur sequential extraction and sulfur isotope analysis.

11. The method of claim 1, wherein the elemental analysis further comprises measuring other radioactive minerals.

12. The method of claim 11, wherein the other radioactive minerals are selected from the group consisting of thorium (“Th”), vanadium (“V”), potassium (“K”), and combinations thereof.

13. The method of claim 1, wherein the evaluating comprises identifying each core sample by gamma-ray intensity.

14. The method of claim 1, wherein the evaluating comprises sorting the first and second portions according to gamma-ray intensity.

15. The method of claim 1, wherein evaluating the U concentration for the presence of negative correlation with the sulfate-pyrite difference quantity comprises:
associating U concentration values for core samples in the second portion with sulfate-pyrite difference quantity values for core samples in the first portion having similar gamma-ray intensity to obtain a relationship between the U concentration and the sulfate-pyrite difference; and
performing a regression on the relationship to determine the presence of negative correlation with the sulfate-pyrite difference.

16. The method of claim 1, wherein evaluating the gamma-ray intensity for the presence of negative correlation with the sulfate-pyrite difference quantity comprises:
associating gamma-ray values for core samples in the first portion with the sulfate-pyrite difference quantity values for the respective core samples to obtain a relationship between the U concentration and the sulfate-pyrite difference; and
performing a regression on the relationship to determine the presence of negative correlation with the sulfate-pyrite difference.

17. The method of claim 1, wherein the pyrite oxidation comprises abiotic oxidation.

18. The method of claim 1, wherein the pyrite oxidation is due to irradiation.

19. The method of claim 18, wherein sulfate was generated due to the irradiation.

20. A method of assessing abiotic oxidation of pyrite by irradiation in petroleum source rocks, comprising:
selecting core samples with high measured gamma-ray intensity, high total organic carbon (“TOC”), and high pyrite contents, where the core samples are of the petroleum source rocks, wherein the petroleum source rocks are from a subsurface formation;
performing sulfur sequential extraction and sulfur isotope analysis to measure the difference between sulfur isotope composition of sulfate and pyrite, Δ³⁴S_{sulfate-pyrite};
performing elemental analysis to measure contents of uranium (“U”) and other radioactive minerals; and
evaluating the gamma-ray intensity and the U contents for correlation with the measured Δ³⁴S_{sulfate-pyrite}; and
associating a negative correlation between U content and gamma-ray intensity on one side and the measured Δ³⁴S_{sulfate-pyrite} on another side with sulfate generated as a result of irradiation from uranium and the other radioactive minerals in the subsurface formation.
